(19) United States
(12) Patent Application Publication
(10) Pub. No.: US 2022/0165171 A1
(43) Pub. Date: May 26, 2022

(54) METHOD FOR ENHANCING AUDIO-VISUAL ASSOCIATION BY ADOPTING SELF-SUPERVISED CURRICULUM LEARNING

(71) Applicant: University of Electronic Science and Technology of China, Chengdu (CN)

(72) Inventors: Xing XU, Chengdu (CN); Jingran ZHANG, Chengdu (CN); Fumin SHEN, Chengdu (CN); Jie SHAO, Chengdu (CN); Hengtao SHEN, Chengdu (CN)

(21) Appl. No.: 17/535,675

(22) Filed: Nov. 25, 2021

(30) Foreign Application Priority Data
Nov. 25, 2020 (CN) 202011338294.0

(51) Int. Cl. G09B 5/06; G06V 10/44; G06V 10/26

(52) U.S. Cl. CPC G09B 5/065; G06V 10/26; G06V 10/454

(57) ABSTRACT

The disclosure provides a method for enhancing audio-visual association by adopting self-supervised curriculum learning. With the help of contrastive learning, the method can train the visual and audio model without human annotation and extracts meaningful visual and audio representations for a variety of downstream tasks in the context of a teacher-student network paradigm. Specifically, a two-stage self-supervised curriculum learning scheme is proposed to contrast the visual and audio pairs and overcome the difficulty of transferring between visual and audio information in the teacher-student framework. Moreover, the knowledge shared between audio and visual modality serves as a supervisory signal for contrastive learning. In summary, with the large-scale unlabeled data, the method can obtain a visual and an audio convolution encoder. The encoders are helpful for downstream tasks and cover the training shortage causing by limited data.

### CROSS-REFERENCE TO RELAYED APPLICATIONS

Pursuant to 35 U.S.C. § 119 and the Paris Convention Treaty, this application claims foreign priority to Chinese Patent Application No. 202011338294.0 filed Nov. 25, 2020, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to the multi-modality analysis of visual and audio representation learning, and more particularly to a self-supervised curriculum learning method for enhancing audio-visual association.

In recent years, with the fast development of the acquisition capabilities of video capture devices, like smartphones, ground surveillance, and internet technology, video data is exponentially growing and can easily reach the scale of gigabytes per day. Rich visual and audio information is contained in those video data. Therefore, mining knowledge and understanding the content of those video data have significant academic and commercial value. However, the major difficulty of discovering video information using traditional supervised learning lies in the human annotations, which are laborious, time-consuming, and expensive but are necessary to enable the supervised training of the Convolutional Neural Networks (CNNs). To dig out inherent information and take advantage of such scale unlabeled video data generated every day, the community of self-supervised learning (SSL) has been developed for utilizing the intrinsic characteristics of unlabeled data and improving the performance of CNNs. Moreover, learning from the video data itself unleashes its potential of easy access property, and accelerates many applications in artificial intelligence where annotating data is difficult.

The self-supervised studies on visual and audio representations learning using co-occurrence property have become an important research direction. The visual and audio representation learning approach regards the pervasive property of audiovisual concurrency as latent supervision to extract features. To this end, various downstream tasks, like action recognition and audio recognition, are evaluated for extracted feature representation. The recent methods on visual and audio self-supervised representations learning can be generally categorized into two types:

(1) Audio-Visual Correspondence (AVC): the visual and audio are always presented in pairs for self-supervised learning

(2) Audio-Visual Synchronization (AVS): the audio is generated by the vibration of the surrounding object for self-supervised learning.

Both two types are mainly about setting up a verification task that predicts whether or not an input pair of an audio and a video clip is matched. The positive audio and video pairs are typically sampled from the same video. The main difference between AVC and AVS is how to treat the negative audio and video pair. Specifically, the negative pair in AVC is mostly constructed by audio and video from different videos while in AVS is to detect the misalignments between negative audio and video pair from the same video.

Conventionally, directly conducting the verification that whether the visual and audio modality derives from the same video for self-supervised representation learning leads to the following disadvantages:

(1) The verification mainly considers the information shared between two modalities for semantic representation learning, but neglects the important cues of the single audio and video modality structure. For example, both crowd cheering and announcer speaking are in basketball and football scenario, so one cannot distinguish it without hearing ball bouncing or kicking; the voice of ball bouncing and kicking is crucial in the audio modality, and the shape of the ball and dressing of the player is crucial in the visual modality.

(2) Besides, only considering the similarity between matching input audio and video visual pairs in a small number of cases is difficult to conduct non-matching pair mining in a complex case.

### SUMMARY

The disclosure provides a method for enhancing audio-visual association by adopting self-supervised curriculum learning, which not only focuses on the correlation between visual and audio modal, but also explores the inherited structure of a single modal. The teacher-student pipeline is adopted to learn the correspondence between visual and audio. Specifically, taking advantage of contrastive learning, a two-stage scheme is exploited, which transfers the cross-modal information between teacher and student model as a phased process. Moreover, the disclosure regards the pervasive property of audiovisual concurrency as latent supervision and mutually distills the structure knowledge of visual to audio data for model training. To this end, the learned discriminative audio and visual representations from the teacher-student pipeline are exploited for downstream action and audio recognition.

Specifically, the disclosure provides a method for enhancing audio-visual association by adopting self-supervised curriculum learning, the method comprising:

1) supposing an unlabeled video dataset [symbol] comprising N samples and being expressed as [symbol] ={Vᵢ}ᵢ₌₁^{N} where Vᵢ represents a sampled clip of an i-th video in the dataset V and comprises T frames; T is a length of a clip Vᵢ; pre-processing videos as visual frame sequence signals and audio spectrum signals, and a pre-processed video dataset being expressed as [symbol] ={Vᵢ=(xᵢ^{v},xᵢ^{a})|x^{v}∈ [symbol] ^{v}, x^{a}∈ [symbol] ^{a}}ᵢ₌₁^{N}, where [symbol] ^{v} is a visual frame sequence set and [symbol] ^{a} is an audio spectrum set, and xᵢ^{v} xᵢ^{a} are an i-th visual sample and an audio sample, respectively:

extracting visual and audio features through convolution neural network to train a visual and audio encoder [symbol] ^{v}, [symbol] ^{a} to generate uni-modal representation f^{v}, f^{a} by exploiting a correlation of audio and visual within each video clip; wherein a feature extraction process is formulated as follows:

$$\{ \begin{matrix}{f}_{i}^{v} = {ℱ}^{v} ( {x}_{i}^{v} ) \\ {f}_{i}^{a} = {ℱ}^{a} ( {x}_{i}^{a} )\end{matrix} , \qquad$$

where fᵢ^{v} is an i-th visual feature and fᵢ^{a} is an i-th audio feature, i={1, 2, . . . , N};

2) performing self-supervised curriculum learning with extracted visual features fᵢ^{v} and audio features fᵢ^{a};

2.1) performing a first stage curriculum learning; in this stage, training the visual features fᵢ^{v} through contrastive learning in a self-supervised manner; the contrastive learning being expressed as:

$${ℒ}_{1} ( {f}_{i}^{v} , {f}^{v} ) = - {\sum }_{i = 1}^{N} 𝔼 [ log \frac{exp ( {f}_{i}^{v} \cdot {{f}_{i}}^{{v}^{′}} ) / τ}{exp ( {f}_{i}^{v} \cdot {f}_{i}^{{v}^{′}} ) / τ + {\sum }_{j = 1 , j \neq i}^{K} exp ( {f}_{i}^{v} \cdot {f}_{j}^{v} ) / τ} ] ,$$

where [symbol] [⋅] is an expected function, log(⋅) is a logarithmic function, exp(⋅) is an exponential function; τ denotes a temperate parameter, K denotes a number of negative samples; fᵢ^{v′} is a feature extracted from visual sample xᵢ^{v′} augmented from xᵢ^{v}, and a calculation thereof is fᵢ^{v′}= [symbol] ^{v}(xᵢ^{v′}); a visual augmentation operations are formulated as:

$${x}_{i}^{{v}^{′}} = Tem ( {\sum }_{s} Spa ( {\sum }_{i = 1 + s}^{T + s} {x}_{i}^{v} ) ) ,$$

where Tem(⋅) are visual clip sampling and temporal jittering function and s is a jitter step; Spa(⋅) are a set of image pre-processing functions comprising image cropping, image resizing, and image flipping, and T is a clip length;

training the audio features fᵢ^{a} in a self-supervised manner through contrastive learning as follows:

$${ℒ}_{2} ( {f}_{i}^{a} , {f}^{a} ) = - {\sum }_{i = 1}^{N} 𝔼 [ log \frac{exp ( {f}_{i}^{a} \cdot {f}_{i}^{{a}^{′}} ) / τ}{exp ( {f}_{i}^{a} \cdot {f}_{i}^{{a}^{′}} ) / τ + {\sum }_{j = 1 , j \neq i}^{K} exp ( {f}_{i}^{a} \cdot {f}_{j}^{a} ) / τ} ] ,$$

where fᵢ^{a′} is a feature extracted from audio sample xᵢ^{a′} which is augmented from xᵢ^{a}, and a calculation thereof denotes as fᵢ^{a′}= [symbol] ^{a}(xᵢ^{a′}); an audio augmentation operation being denoted as:

xᵢ^{a′}=Wf(Mfc(Mts(xᵢ^{a}))),

where Mts(⋅) is a function of masking blocks of a time step, Mfc(⋅) denotes a function of masking blocks of frequency channels and Mf(⋅) is a feature wrapping function;

procedures in the first stage curriculum learning are seen as a self-instance discriminator by directly optimizing in feature space of visual or audio respectively; after the procedures, visual feature representations and audio feature representations are discriminative, which means resulting representations are distinguishable for different instances.

2.2) Performing a second stage curriculum learning; in this stage, transferring information between visual representation fᵢ^{v} and audio representation fᵢ^{a} with a teacher-student framework for contrastive learning and training, the teacher-student framework being expressed as follows:

$${ℒ}_{3} ( {f}_{i}^{v} , {f}^{a} ) = - {\sum }_{i = 1}^{N} 𝔼 [ log \frac{exp ( {f}_{i}^{v} \cdot {f}_{i}^{a} ) / τ}{exp ( {f}_{i}^{v} \cdot {f}_{i}^{a} ) / τ + {\sum }_{j = 1 , j \neq i}^{K} exp ( {f}_{i}^{v} \cdot {f}_{j}^{a} ) / τ} ] ,$$

where (fᵢ^{v}, fᵢ^{a}) is a positive pair, and (fᵢ^{v},fⱼ^{a}), i≠j is a negative pair;

with this stage, a student network output is encouraged to be as similar as possible to teachers' by optimizing above objective with input pairs.

3) Optimizing using a memory-bank mechanism;

In the first and second stages of curriculum learning, the key idea is to apply contrastive learning to learn the intrinsic structure of audio and visual in the video. However, solving the objective of this approach typically suffers the issue of the existence of trivial constant solutions. Therefore, the method uses one positive pair and K negative pairs for training. In the ideal case, the number of negative pairs should be set as K=N−1 in the whole video dataset V, which consumes a high computation cost and cannot directly deploy in practice. To address this issue, the method further comprises providing a visual memory bank [symbol] ^{v}={m^{v}}ᵢ₌₁^{K′}, and an audio memory bank [symbol] ^{a}={mᵢ^{a}}ᵢ₌₁^{K′} to store negative pairs in the first stage curriculum learning and the second stage curriculum learning, wherein the visual memory bank and the audio memory bank are easily optimized without large computation consumption for training; a bank size K′ is set as 16384, and the visual memory bank and the audio memory bank are dynamically evolving during a curriculum learning process, with formulas as follows

$$\{ \begin{matrix}{m}_{i}^{v} ← {f}_{i}^{v} \\ {m}_{i}^{a} ← {f}_{i}^{a}\end{matrix} ,$$

where fᵢ^{v}, fᵢ^{a} are visual and audio features learned in a specific iteration step of the curriculum learning process. The mentioned visual and audio banks are dynamically evolving with the video dataset and keep a fixed size, and thus the method has a variety of negative samples using a small cost. Both ways are able to replace negative samples with the bank representations without increasing the training batch size.

4) Performing downstream task of action and audio recognition;

following the curriculum learning process in a self-supervised manner, acquiring a pre-trained visual convolutional encoder [symbol] ^{v} and an audio convolutional encoder [symbol] ^{a}; to investigate a correlation between visual and audio representations, transferring the pre-trained visual convolutional encoder and the audio convolutional encoder to action recognition and audio recognition based on trained visual convolutional encoder [symbol] ^{v} and audio convolutional encoder [symbol] ^{a}, with formulas as follows:

$$\{ \begin{matrix}{y}_{v}^{*} = arg {max}_{y} ( ℙ ( y ; {x}^{v} , {ℱ}^{v} ) ) \\ {y}_{a}^{*} = arg {max}_{y} ( ℙ ( y ; {x}^{a} , {ℱ}^{a} ) ) \end{matrix} ,$$

where yᵥ* is a predicted action label of visual frame sequence x^{v}, yₐ* is a predicted audio label of audio signal x^{a}, y is a label variable; argmax(⋅) is an argument of a maxima function, and [symbol] (⋅) is a probability function.

To take advantage of the large-scale unlabeled video data and learn the visual and audio representation, the disclosure presented a self-supervised curriculum learning method for enhancing audio-visual association with contrastive learning in the context of a teacher-student network paradigm. This method can train the visual and audio model without human annotation and extracts meaningful visual and audio representations for a variety of downstream tasks. Specifically, a two-stage self-supervised curriculum learning scheme is proposed by solving the task of audio-visual correspondence learning. The rationale behind the disclosure is that the knowledge shared between audio and visual modality serves as a supervisory signal. Therefore, it is helpful for downstream tasks which have limited training data by using the pre-trained model learned with the large-scale unlabeled data. Concisely, without any human annotation, the disclosure exploits the relation between visual and audio to pre-train model. Afterward, it applies the pre-trained model in an end-to-end manner for downstream tasks.

### BRIEF DESCRIPTION OF THE DRAWINGS

FIG. 1 shows a framework of a method for enhancing audio-visual association by adopting self-supervised curriculum learning of the disclosure; and

FIG. 2 visualizes the qualitative result of the similarity between visual and audio pairs.

### DETAILED DESCRIPTION OF THE PREFERRED EMBODIMENTS

To further illustrate, experiments detailing a method for enhancing audio-visual association by adopting self-supervised curriculum learning are described below. It should be noted that the following examples are intended to describe and not to limit the description.

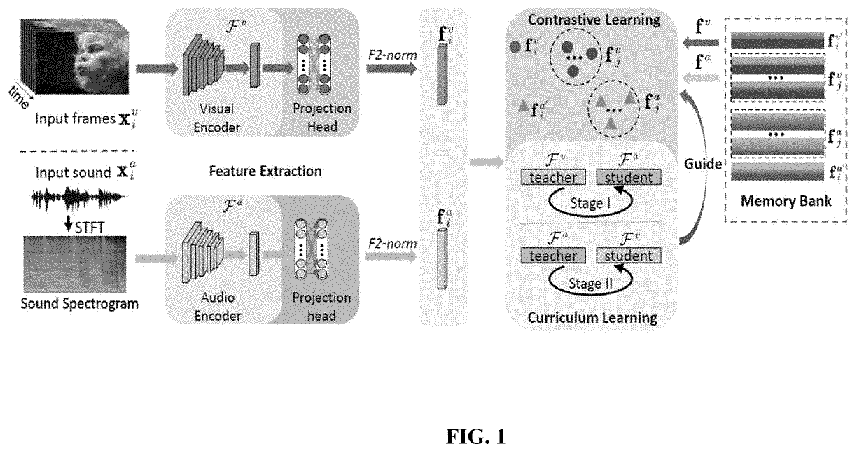

FIG. 1 shows a framework of a method for enhancing audio-visual association by adopting self-supervised curriculum learning in the disclosure.

The method, as shown in FIG. 1, detailed as follows:

Step 1: Using convolution neural network to extract visual and audio features.

Suppose an unlabeled video dataset V comprises N samples and expresses as [symbol] ={Vᵢ}ᵢ₌₁^{N}, where Vᵢ represents a sampled clip of the i-th video in the dataset [symbol] and contains T frames; T is the length of clip Vᵢ. Since the dataset [symbol] comprises no ground-truth labels for later training, the videos are pre-processed as visual frame sequence signals and audio spectrum signals, and the pre-processed video dataset expresses as [symbol] ={Vᵢ=(xᵢ^{v},xᵢ^{a})|x^{v}∈ [symbol] ^{v}, x^{a}∈ [symbol] ^{a}}ᵢ₌₁^{N}, where [symbol] ^{v} is visual frame sequence set and [symbol] ^{a} is audio spectrum set; xᵢ^{v} and xᵢ^{a} are i-th visual sample and an audio sample, respectively. Afterward, the method can utilize the latent correlation of visual and audio signal for self-supervised training. The goal is to effectively train a visual and audio encoder [symbol] ^{v}, [symbol] ^{a} to generate uni-modal representation f^{v}, f^{a} by exploiting the correlation of audio and visual within each video clip. The feature extraction process can be formulated as follows:

$$\{ \begin{matrix}{f}_{i}^{v} = {ℱ}^{v} ( {x}_{i}^{v} ) \\ {f}_{i}^{a} = {ℱ}^{a} ( {x}_{i}^{a} )\end{matrix} , \qquad$$

where fᵢ^{v} is the i-th visual feature and fᵢ^{a} is the i-th audio feature, i={1, 2, . . . , N}.

Step 2: Self-supervised curriculum learning with the extracted visual features fᵢ^{v} and audio features fᵢ^{a}.

Step 2.1: The first stage curriculum learning.

In this stage, contrastive learning is adopted to train the visual features f y in a self-supervised manner. The whole process is expressed as:

$${ℒ}_{1} ( {f}_{i}^{v} , {f}^{v} ) = - {\sum }_{i = 1}^{N} 𝔼 [ log \frac{exp ( {f}_{i}^{v} \cdot {f}_{i}^{{v}^{′}} ) / τ}{exp ( {f}_{i}^{v} \cdot {f}_{i}^{{v}^{′}} ) / τ + {\sum }_{j = 1 , j \neq i}^{K} exp ( {f}_{i}^{v} \cdot {f}_{j}^{v} ) / τ} ] ,$$

where [symbol] [⋅] is the expected function, log(⋅) is the logarithmic function, exp(⋅) is the exponential function; τ denotes the temperate parameter, K denotes the number of negative samples; fᵢ^{v′} is the feature extracted from visual sample xᵢ^{v′} that is augmented from xᵢ^{v}, and the procedure is fᵢ^{v′}= [symbol] ^{v}(xᵢ^{v′}). Additionally, the visual augmentation operations are formulated as:

$${x}_{i}^{{v}^{′}} = Tem ( {\sum }_{s} Spa ( {\sum }_{i = 1 + s}^{T + s} {x}_{i}^{v} ) ) ,$$

where Tem(⋅) are visual clip sampling and temporal jittering function and s is the jitter step; Spa(⋅) are a set of image pre-processing functions, like image cropping, image resizing, image flipping, etc., and Tis the clip length.

Afterward, the same self-supervised pre-training process is also applied to audio features fᵢ^{a} and expresses as:

$${ℒ}_{2} ( {f}_{i}^{a} , {f}^{a} ) = - {\sum }_{i = 1}^{N} 𝔼 [ log \frac{exp ( {f}_{i}^{a} \cdot {f}_{i}^{{a}^{′}} ) / τ}{exp ( {f}_{i}^{a} \cdot {f}_{i}^{{a}^{′}} ) / τ + {\sum }_{j = 1 , j \neq i}^{K} exp ( {f}_{i}^{a} \cdot {f}_{j}^{a} ) / τ} ] ,$$

where fᵢ^{a′} is the feature extracted from audio sample xᵢ^{a′} which is augmented from xᵢ^{a}, and the procedure denotes as fᵢ^{a′}= [symbol] ^{a}(xᵢ^{a′}). The audio augmentation operations denote as:

xᵢ^{a′}= [symbol] ^{a}(Mfc(Mts(xᵢ^{a}))),

where Mts(⋅) is the function of masking blocks of the time step, Mfc(⋅) denotes the function of masking blocks of frequency channels and Mf(⋅) is the feature wrapping function.

This first stage procedure in curriculum learning is seen as a self-instance discriminator by directly optimizing in feature space of visual or audio respectively. After the pre-trained process, the visual feature representations and audio feature representations are discriminative, which means the resulting representations are distinguishable for different instances.

Step 2.2: The second stage curriculum learning.

In this stage, the method transfers information between visual representation fᵢ^{v} and audio representation fᵢ^{a} with a teacher-student framework. Contrastive learning is also adopted for training and is expressed as:

$${ℒ}_{3} ( {f}_{i}^{v} , {f}^{a} ) = - {\sum }_{i = 1}^{N} 𝔼 [ log \frac{exp ( {f}_{i}^{v} \cdot {f}_{i}^{a} ) / τ}{exp ( {f}_{i}^{v} \cdot {f}_{i}^{a} ) / τ + {\sum }_{j = 1 , j \neq i}^{K} exp ( {f}_{i}^{v} \cdot {f}_{j}^{a} ) / τ} ] ,$$

where (fᵢ^{v},fᵢ^{a}) is positive pair, while (fᵢ^{v},fⱼ^{a}), i≠j is negative pair.

With this process, the method encourages the student network output to be as similar as possible to the teachers' by optimizing the above objective with the input pairs.

Step 3. Using the memory-bank mechanism for optimizing.

In the first and second stages of curriculum learning, the key idea is to apply contrastive learning to learn the intrinsic structure of audio and visual in the video. However, solving the objective of this approach typically suffers the issue of the existence of trivial constant solutions. Therefore, the method uses one positive pair and K negative pairs for training. In the ideal case, the number of negative pairs should be set as K=N−1 in the whole video dataset V, but it will consume a high computation cost and cannot directly deploy in practice. To address this issue, the curriculum learning maintains a visual memory bank [symbol] ^{v}={m^{v}}ᵢ₌₁^{K′} and an audio memory bank [symbol] ^{a}={mᵢ^{a}}ᵢ₌₁^{K′} to store negative pairs, which can easily optimize without large computation consumption for training. The bank size K′ is set as 16384 in the method, and the two different banks are dynamically evolving during the curriculum learning process. It formulates as:

$$\{ \begin{matrix}{m}_{i}^{v} ← {f}_{i}^{v} \\ {m}_{i}^{a} ← {f}_{i}^{a}\end{matrix} ,$$

where fᵢ^{v}, fᵢ^{a} are visual and audio features learned in a specific iteration step of the curriculum learning process. Since the mentioned visual and audio banks are dynamically evolving with the video dataset and keep a fixed size, so that the method has a variety of negative samples using a small cost. Both ways can be used to replace negative samples with the bank representations without increasing the training batch size.

Step 4: Downstream task of action and audio recognition.

After the self-supervised curriculum learning process, the method will obtain a pre-trained visual convolutional encoder [symbol] ^{v} and audio convolutional encoder [symbol] ^{a}. To further investigate the correlation between visual and audio representations, downstream tasks will be conducted by transferring the pre-trained visual convolutional encoder and the audio convolutional encoder to action recognition and audio recognition based on [symbol] ^{v} and [symbol] ^{a} with formulas as follows:

$$\{ \begin{matrix}{y}_{v}^{*} = arg {max}_{y} ( ℙ ( y ; {x}^{v} , {ℱ}^{v} ) ) \\ {y}_{a}^{*} = arg {max}_{y} ( ℙ ( y ; {x}^{a} , {ℱ}^{a} ) ) \end{matrix} ,$$

where yᵥ* is the predicted action label of visual frame sequence x^{v}, yₐ* is the predicted audio label of audio signal x^{a}, y is the label variable; argmax(⋅) is the arguments of the maxima function and [symbol] (⋅) is the probability function.

### Example 1

The disclosure first applies Kinetics-400 dataset as the pre-trained unlabeled benchmark, which comprises 306,000 video clips available on YouTube website. 221.065 videos among that are sampled from the training set for visual and audio representation learning. It is also a widely used dataset for self-supervised visual and audio representation learning. Afterward, the classification accuracies of downstream action and audio recognition are exploited for evaluating the pre-trained model in the disclosure. Specifically, top-k accuracy is adopted to evaluate the model generated in the disclosure. Top-k is the proportion of the correct label within the top k classes predicted by the model. It is a widely used metric in recognition area and set as 1 in the implementation. The large-scale action recognition benchmark of the UCF-101 and the EIMDB-51 datasets are exploited to evaluate the implementation of action recognition. The UCF-101 dataset comprises 101 action classes with 13320 short video clips. The EIMDB-51 dataset has 6766 video clips with 51 categories. The evaluation results about action recognition in this implementation are shown in Table 1.

TABLE 1
The evaluation results on UCF-101 and HMDB-51 datasets

| Method | Pre-train dataset | Backbone | Size |
|---|---|---|---|
| From scratch | — | S3D | 16 × 224 × 224 |
| Shuffle & | UCF101/HMDB51 | CaffeNet | 1 × 227 × 227 |
| Learn | | | |
| Geometry | UCF101/HMDB51 | FlowNet | 1 × 227 × 227 |
| OPN | UCF101/HMDB51 | CaffeNet | 1 × 227 × 227 |
| ST order | UCF101/HMDB51 | CaffeNet | 1 × 227 × 227 |
| Cross & | UCF101/HMDB51 | CaffeNet | 1 × 227 × 227 |
| Learn | | | |
| CMC | UCF101/HMDB51 | CaffeNet | 11 × 227 × 227 |
| RotNet3D* | Kinetics-400 | 3D-ResNet18 | 16 × 122 × 122 |
| 3D-ST-Puzzle | Kinetics-400 | 3D-ResNet18 | 16 × 122 × 122 |
| Clip-order | Kinetics-400 | R(2 + 1)D-18 | 16 × 122 × 122 |
| DPC | Kinetics-400 | Custom | 25 × 224 × 224 |
| | | 3D-ResNet | |
| Multisensory | Kinetics-400 | 3D-ResNet18 | 64 × 224 × 224 |
| CBT* | Kinetics-400 | S3D | 16 × 122 × 122 |
| L³-Net | Kinetics-400 | VGG-16 | 16 × 224 × 224 |
| AVTS | Kinetics-400 | MC3-18 | 25 × 224 × 224 |
| XDC* | Kinetics-400 | R(2 + 1)D-18 | 32 × 224 × 224 |
| First Stage | Kinetics-400 | S3D | 16 × 122 × 122 |
| Second Stage | Kinetics-400 | S3D | 16 × 122 × 122 |
| First Stage | Kinetics-400 | S3D | 16 × 224 × 224 |
| Second Stage | Kinetics-400 | S3D | 32 × 224 × 224 |
| Parameters | Flops | UCF101 | HMDB51 |
| 8.3M | 18.1 G | 52.7 | 39.2 |
| 58.3M | 7.6 G | 50.2 | 18.1 |
| — | — | 54.1 | 22.6 |
| 58.3M | 7.6 G | 56.3 | 23.8 |
| 58.3M | 7.6 G | 58.6 | 25.0 |
| 58.3M | 7.6 G | 58.7 | 27.2 |
| 58.3M | 83.6 G | 59.1 | 26.7 |
| 33.6M | 8.5 G | 62.9 | 33.7 |
| 33.6M | 8.5 G | 63.9 | 33.7 |
| 33.3M | 8.3 G | 72.4 | 30.9 |
| 32.6M | 85.9 G | 75.7 | 35.7 |
| 33.6M | 134.8 G | 82.1 | — |
| 8.3M | 4.5 G | 79.5 | 44.6 |
| 138.4M | 113.6 G | 74.4 | 47.8 |
| 11.7M | — | 85.8 | 56.9 |
| 33.3M | 67.4 G | 84.2 | 47.1 |
| 8.3M | 4.5 G | 81.4 | 47.7 |
| 8.3M | 4.5 G | 82.6 | 49.9 |
| 8.3M | 18.1 G | 84.3 | 54.1 |
| 8.3M | 36.3 G | 87.1 | 57.6 |

Furthermore, ESC-50 and DCASE datasets are exploited to evaluate the audio representation. ESC-50 contains 2000 audio clips from 50 balanced environment sound classes, and DCASE has 100 audio clips from 10 balanced scene sound classes. The evaluation results about audio recognition in this implementation are shown in Table 2.

TABLE 2
The evaluation results on ESC-50 and DCASE datasets

| | | | | DCASE |
|---|---|---|---|---|
| Method | Pre-train dataset | Backbone | ESC-50(%) | (%) |
| From scratch | — | 2D-ResNet10 | 51.3 | 75.0 |
| CovNet | ESC-50/DCASE | Custom-2 CNN | 64.5 | — |
| ConvRBM | ESC-50/DCASE | Custom-2 CNN | 86.5 | — |
| SoundNet | Flickr-SoundNet | VGG | 74.2 | 88.0 |
| DMC | Flickr-SoundNet | VGG | 82.6 | — |
| L³-Net | Kinetics-400 | VGG | 79.3 | 93.0 |
| AVTS | Kinetics-400 | VGG | 76.7 | 91.0 |
| XDC* | Kinetics-400 | 2D-ResNet18 | 78.0 | — |
| First Stage | Kinetics-400 | 2D-ResNet10 | 85.8 | 91.0 |
| Second Stage | Kinetics-400 | 2D-ResNet10 | 88.3 | 93.0 |

From Table 1 and Table 2, the learned visual and audio representation can be effectively applied to downstream action and audio recognition tasks and provides additional information for small-scale datasets.

### Example 2

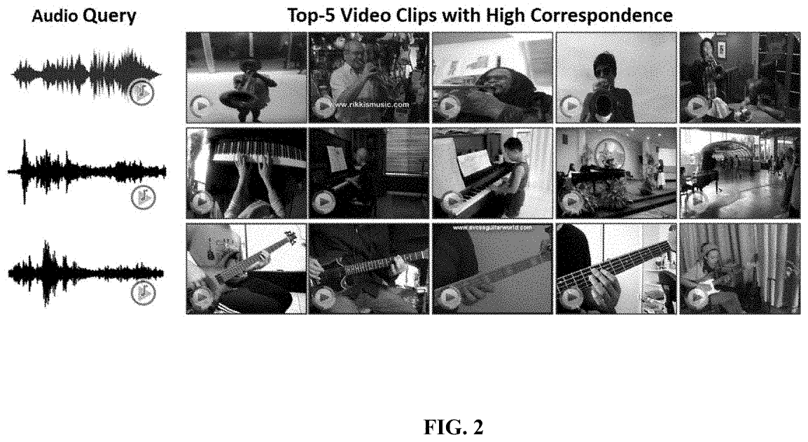

To explore whether the features of audio-visual can be grouped together, this implementation conducts a cross-modal retrieval experiment with a ranked similar value. As shown in FIG. 2, the top-5 positive visual samples are reported according to the query of sound. It can be observed that the disclosure can correlate well the semantically similar acoustical and visual information and group together semantically related visual concepts.

It will be obvious to those skilled in the art that changes and modifications may be made, and therefore, the aim in the appended claims is to cover all such changes and modifications.

What is claimed is:

1. A method for enhancing audio-visual association by adopting self-supervised curriculum learning, the method comprising:
1) supposing an unlabeled video dataset [symbol] comprising N samples and being expressed as [symbol] ={Vᵢ}ᵢ₌₁^{N}, where Vᵢ represents a sampled clip of an i-th video in the dataset [symbol] and comprises T frames; T is a length of a clip vᵢ;
pre-processing videos as visual frame sequence signals and audio spectrum signals, and a pre-processed video dataset being expressed as [symbol] ={Vᵢ=(xᵢ^{v},xᵢ^{a})|x^{v}∈ [symbol] ^{v}, x^{a}∈ [symbol] ^{a}}ᵢ₌₁^{N}, where [symbol] ^{v} is a visual frame sequence set and [symbol] ^{a} is an audio spectrum set, and xᵢ^{v} and xᵢ^{a} are an i-th visual sample and an audio sample, respectively;
extracting visual and audio features of the visual frame sequence signals and the audio spectrum signals through convolution neural network to train a visual and audio encoder [symbol] ^{v}, [symbol] ^{a} to generate uni-modal representation f^{v}, f^{a} by exploiting a correlation of audio and visual within each video clip; wherein a feature extraction process is formulated as follows:
$$\{ \begin{matrix}{f}_{i}^{v} = {ℱ}^{v} ( {x}_{i}^{v} ) \\ {f}_{i}^{a} = {ℱ}^{a} ( {x}_{i}^{a} )\end{matrix} ,$$
where fᵢ^{v} is an i-th visual feature and fᵢ^{a} is an i-th audio feature,
2) performing self-supervised curriculum learning with extracted visual features fᵢ^{v} and audio features fᵢ^{a};
2.1) performing a first stage curriculum learning; in this stage, training the visual features fᵢ^{v} through contrastive learning in a self-supervised manner; the contractive learning being expressed as:
$${ℒ}_{1} ( {f}_{i}^{v} , {f}^{v} ) = - {\sum }_{i = 1}^{N} 𝔼 [ log \frac{exp ( {f}_{i}^{v} \cdot {f}_{i}^{{v}^{′}} ) / τ}{exp ( {f}_{i}^{v} \cdot {f}_{i}^{{v}^{′}} ) / τ + {\sum }_{j = 1 , j \neq i}^{K} exp ( {f}_{i}^{v} \cdot {f}_{j}^{v} ) / τ} ] ,$$
where [symbol] [⋅] is an expected function, log(⋅) is a logarithmic function, exp(⋅) is an exponential function; τ denotes a temperate parameter, K denotes a number of negative samples; fᵢ^{v′} is a feature extracted from visual sample xᵢ^{v′} augmented from xᵢ^{v}, and a calculation thereof is fᵢ^{v′}= [symbol] ^{v}(xᵢ^{v′}); a visual augmentation operations are formulated as:
$${x}_{i}^{{v}^{′}} = Tem ( {\sum }_{s} Spa ( {\sum }_{i = 1 + s}^{T + s} {x}_{i}^{v} ) ) ,$$
where Tem(⋅) are visual clip sampling and temporal jittering function and s is a jitter step; Spa(⋅) are a set of image pre-processing functions comprising image cropping, image resizing, and image flipping, and T is a clip length;
training the audio features fᵢ^{a} in a self-supervised manner through contrastive learning as follows:
$${ℒ}_{2} ( {f}_{i}^{a} , {f}^{a} ) = - {\sum }_{i = 1}^{N} 𝔼 [ log \frac{exp ( {f}_{i}^{a} \cdot {f}_{i}^{{a}^{′}} ) / τ}{exp ( {f}_{i}^{a} \cdot {f}_{i}^{{a}^{′}} ) / τ + {\sum }_{j = 1 , j \neq i}^{K} exp ( {f}_{i}^{a} \cdot {f}_{j}^{a} ) / τ} ] ,$$
where fᵢ^{a′} is a feature extracted from audio sample xᵢ^{a′} which is augmented from xᵢ^{a}, and a calculation thereof denotes as fᵢ^{a′}= [symbol] ^{a}(xᵢ^{a′}); an audio augmentation operation being denoted as:
xᵢ^{a′}=Wf(Mfc(Mts(xᵢ^{a}))),
where Mts(⋅) is a function of masking blocks of a time step, Mfc(⋅) denotes a function of masking blocks of frequency channels and Mf(⋅) is a feature wrapping function;
procedures in the first stage curriculum learning are seen as a self-instance discriminator by directly optimizing in feature space of visual or audio respectively; after the procedures, visual feature representations and audio feature representations are discriminative, which means resulting representations are distinguishable for different instances;
2.2) performing a second stage curriculum learning; in this stage, transferring information between visual representation fᵢ^{v} and audio representation fᵢ^{a} with a teacher-student framework for contrastive learning and training, the teacher-student framework being expressed as follows:
$${ℒ}_{3} ( {f}_{i}^{v} , {f}^{a} ) = - {\sum }_{i = 1}^{N} 𝔼 [ log \frac{exp ( {f}_{i}^{v} \cdot {f}_{i}^{a} ) / τ}{exp ( {f}_{i}^{v} \cdot {f}_{i}^{a} ) / τ + {\sum }_{j = 1 , j \neq i}^{K} exp ( {f}_{i}^{v} \cdot {f}_{j}^{a} ) / τ} ] ;$$
where (fᵢ^{v}, fᵢ^{a}) is a positive pair, and (fᵢ^{v}, fⱼ^{a}), i≠j is a negative pair;
with this stage, a student network output is encouraged to be as similar as possible to teachers' by optimizing above objective with input pairs;
3) optimizing using a memory-bank mechanism;
providing a visual memory bank [symbol] ^{v}={m^{v}}ᵢ₌₁^{K′} and an audio memory bank [symbol] ^{a}={mᵢ^{a}}ᵢ₌₁^{K′} to store negative pairs in the first stage curriculum learning and the second stage curriculum learning, wherein the visual memory bank and the audio memory bank are easily optimized without computation consumption for training; a bank size K′ is set as 16384, and the visual memory bank and the audio memory bank are dynamically evolving during a curriculum learning process, with formulas as follows:
$$\{ \begin{matrix}{m}_{i}^{v} ← {f}_{i}^{v} \\ {m}_{i}^{a} ← {f}_{i}^{a}\end{matrix} ;$$
where fᵢ^{v}, fᵢ^{a} are visual and audio features learned in a specific iteration step of the curriculum learning process;
4) performing downstream task of action and audio recognition;
following the curriculum learning process in a self-supervised manner, acquiring a pre-trained visual convolutional encoder [symbol] ^{v} and an audio convolutional encoder [symbol] ^{a}; to investigate a correlation between visual and audio representations, transferring the pre-trained visual convolutional encoder and the audio convolutional encoder to action recognition and audio recognition based on trained visual convolutional encoder [symbol] ^{v} and audio convolutional encoder [symbol] ^{a}, with formulas as follows:
$$\{ \begin{matrix}{y}_{v}^{*} = arg {max}_{y} ( ℙ ( y ; {x}^{v} , {ℱ}^{v} ) ) \\ {y}_{a}^{*} = arg {max}_{y} ( ℙ ( y ; {x}^{a} , {ℱ}^{a} ) ) \end{matrix} ;$$
where yᵥ* is a predicted action label of visual frame sequence x^{v}, yₐ* is a predicted audio label of audio signal x^{a}, y is a label variable; argmax(⋅) is an argument of a maxima function, and [symbol] (⋅) is a probability function.

2. The method of claim 1, wherein request parameters in 2) are set as follows:
τ=0.07,K=N−1,s=4,T=16.

3. The method of claim 2, wherein the image pre-processing functions Spa(⋅) comprise image cropping, horizontal flipping, and gray transformation.
